(19) United States
(12) Patent Application Publication
(10) Pub. No.: US 2026/0211175 A1
(43) Pub. Date: Jul. 23, 2026

(54) OPTICAL TRANSMISSION LINE AND CONNECTION METHOD

(71) Applicant: NTT, Inc., Tokyo (JP)

(72) Inventors: Atsushi NAKAMURA, Musashino-shi, Tokyo (JP); Yusuke KOSHIKIYA, Musashino-shi, Tokyo (JP)

(73) Assignee: NTT, Inc., Tokyo (JP)

(21) Appl. No.: 19/134,380

(22) PCT Filed: Dec. 26, 2022
(86) PCT No.: PCT/JP2022/047896

§ 371 Date: May 30, 2025

(51) Int. Cl. G02B 6/10

(52) U.S. Cl. CPC G02B 6/10

(57) ABSTRACT

The present disclosure is an optical transmission line including: a plurality of multicore optical fiber transmission lines; two input/output devices that are positioned at both ends of the plurality of multicore optical fiber transmission lines, and configured to input light to or output light from a plurality of cores of the multicore optical fiber transmission lines; and a switching connection device that is positioned between the multicore optical fiber transmission lines and the input/output devices, and configured to switch connections of the individual cores of the multicore optical fiber transmission lines to individual cores of a multicore optical fiber of the input/output devices.

### TECHNICAL FIELD

The present disclosure relates to connection of multicore optical fiber transmission lines.

### BACKGROUND ART

Uncoupled multicore optical fibers are considered to be promising optical fibers for realizing large-capacity optical communication in the future (see, for example, Patent Literature 1). The multicore optical fibers each have a plurality of cores in the cladding. In order to identify each core, a marker for core number identification may be disposed. Each core number can be grasped by the positional relationship with the marker.

FIG. 1 illustrates an example in which a plurality of multicore optical fiber transmission lines are connected. In FIG. 1, reference numerals 103 denote the multicore optical fiber transmission lines, a reference numeral 106 denotes a core, and a reference numeral 107 denotes a marker. In a case where the plurality of multicore optical fiber transmission lines 103 are connected, the positions of the markers 107 are uniform at connection points, so that light can be input to and output from a predetermined channel by input/output devices at both ends of the plurality of multicore optical fiber transmission lines 103.

### CITATION LIST

### Patent Literature

Patent Literature 1: JP 2020-115191 A

### SUMMARY OF INVENTION

### Technical Problem

However, in regard to connecting the plurality of multicore optical fiber transmission lines 103, before the multicore optical fiber transmission lines 103 are connected, the markers 107 need aligning at the connection points, so that it takes a lot of time to construct or operate an optical transmission line. This leads to cost increase in the phase of constructing or operating the optical transmission line.

The present disclosure has been devised in view of the above circumstances, and an object thereof is to provide an optical transmission line and a connection method capable of shortening a time spent on connecting a plurality of multicore optical fiber transmission lines.

### Solution to Problem

In order to achieve the above object, in an optical transmission line and a connection method of the present disclosure, a plurality of multicore optical fiber transmission lines are connected without confirming the positions of markers of the multicore optical fiber transmission lines regardless of the presence or absence of the markers, and a switching connection device is positioned between the multicore optical fiber transmission lines and an input/output device, and switches connections of individual cores of the multicore optical fiber transmission lines to individual cores of a multicore optical fiber of the input/output device.

Specifically, an optical transmission line of the present disclosure includes:
a plurality of multicore optical fiber transmission lines;
two input/output devices that are positioned at both ends of the plurality of multicore optical fiber transmission lines, and configured to input light to or output light from a plurality of cores of the multicore optical fiber transmission lines; and
a switching connection device that is positioned between the multicore optical fiber transmission lines and the input/output devices, and configured to switch connections of the individual cores of the multicore optical fiber transmission lines to individual cores of a multicore optical fiber of the input/output devices.

Specifically, a connection method of the present disclosure is
a connection method for
a plurality of multicore optical fiber transmission lines and
two input/output devices that are positioned at both ends of the plurality of multicore optical fiber transmission lines, and configured to input light to or output light from a plurality of cores of the multicore optical fiber transmission lines,
the connection method including:
switching connections of the individual cores of the multicore optical fiber transmission lines to individual cores of a multicore optical fiber of the input/output devices, between the multicore optical fiber transmission lines and the input/output devices.

In order to achieve the above object, in an optical transmission line and a connection method of the present disclosure, while a plurality of multicore optical fiber transmission lines are connected without confirming the positions of markers of the multicore optical fiber transmission lines regardless of the presence or absence of the markers, a switching connection device is positioned between any of the multicore optical fibers, and switches connections of individual cores of the multicore optical fiber transmission lines.

Specifically, an optical transmission line of the present disclosure includes:
a plurality of multicore optical fiber transmission lines;
two input/output devices that are positioned at both ends of the plurality of multicore optical fiber transmission lines, and configured to input light to or output light from a plurality of cores of the multicore optical fiber transmission lines; and
a switching connection device that is positioned between any of the multicore optical fiber transmission lines, and configured to switch connections of the individual cores of the multicore optical fiber transmission lines.

Specifically, a connection method of the present disclosure is
a connection method for
a plurality of multicore optical fiber transmission lines and
two input/output devices that are positioned at both ends of the plurality of multicore optical fiber transmission lines, and configured to input light to or output light from a plurality of cores of the multicore optical fiber transmission lines,
the connection method including:
switching connections of the individual cores of the multicore optical fiber transmission lines, between any of the multicore optical fiber transmission lines.

The switching connection device of the optical transmission line of the present disclosure is configured to switch the connections of the individual cores disposed on a concentric circle of one multicore optical fiber to the individual cores disposed on a concentric circle of another opposite multicore optical fiber by rotation of the one multicore optical fiber on a central axis thereof.

Note that the above-described disclosures can be combined in any possible manner.

### Advantageous Effects of Invention

The present disclosure can provide an optical transmission line and a connection method capable of shortening a time spent on connecting a plurality of multicore optical fiber transmission lines.

### BRIEF DESCRIPTION OF DRAWINGS

FIG. 1 is a diagram for illustrating an example of connecting a plurality of multicore optical fiber transmission lines.

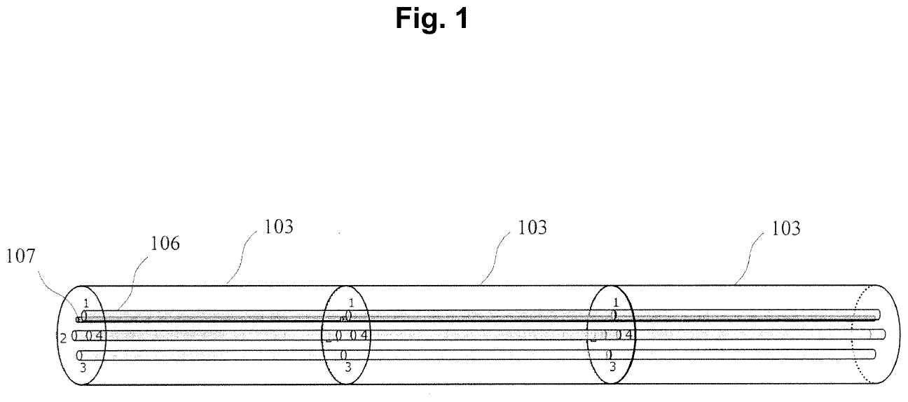

FIG. 2 is a diagram for illustrating a configuration example of an optical transmission line of the present embodiment.

FIG. 3 is a diagram for illustrating a configuration example of a switching connection device of the present embodiment.

FIG. 4 is a diagram for illustrating a configuration example of a switching connection device of the present embodiment.

### DESCRIPTION OF EMBODIMENTS

Hereinafter, an embodiment of the present disclosure will be described in detail with reference to the drawings. Note that the present disclosure is not limited to the embodiments described below. These embodiments are merely examples, and the present disclosure can be implemented in a form with various modifications and improvements based on the knowledge of those skilled in the art. Note that components indicated by the same reference numerals in the present description and the drawings are the same components.

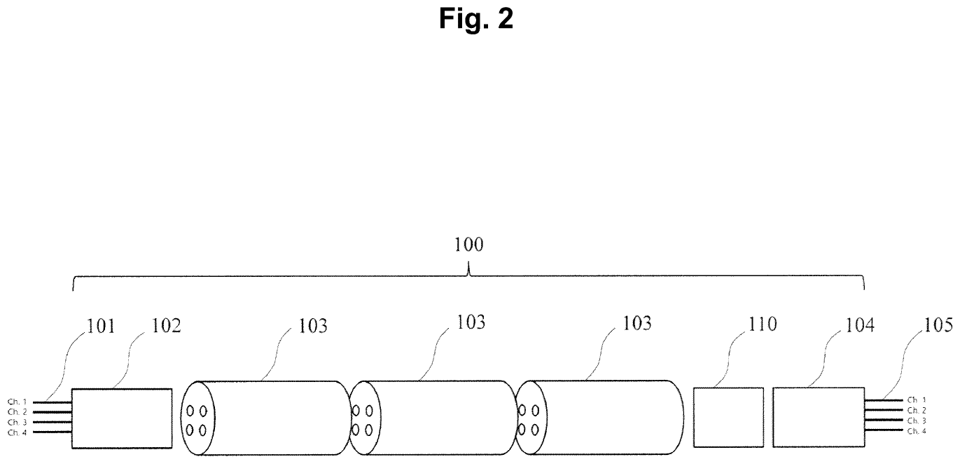

FIG. 2 illustrates a configuration example of an optical transmission line according to the present embodiment. In FIG. 2, a reference numeral 100 denotes an optical transmission line, a reference numeral 101 denotes individual channels, a reference numeral 102 denotes an input/output device, reference numerals 103 denote multicore optical fiber transmission lines, a reference numeral 104 denotes an input/output device, a reference numeral 105 denotes individual channels, and a reference numeral 110 denotes a switching connection device.

The optical transmission line 100 of the present embodiment includes the plurality of multicore optical fiber transmission lines 103, two input/output devices 102 and 104 that are positioned at both ends of the plurality of multicore optical fiber transmission lines 103, and input light to or output light from a plurality of cores of the multicore optical fiber transmission lines 103, and the switching connection device 110 that is positioned between the multicore optical fiber transmission lines 103 and the input/output device 104, and switches connections of the individual cores of the multicore optical fiber transmission lines 103 to individual cores of a multicore optical fiber of the input/output device 104.

In the optical transmission line and the connection method of the present embodiment, cores of the plurality of multicore optical fiber transmission lines 103 are casually connected to each other regardless of the presence or absence of markers of the multicore optical fiber transmission lines 103. Two input/output devices 102 and 104 that input light to or output light from the plurality of cores of the multicore optical fiber transmission lines 103 are positioned at both ends of the plurality of multicore optical fiber transmission lines 103. The switching connection device 110 is positioned between the multicore optical fiber transmission lines 103 and the input/output device 104, and switches connections of the individual cores of the multicore optical fiber transmission lines 103 to individual cores of the multicore optical fiber of the input/output device 104.

Regardless of the presence or absence of the markers, cores of the plurality of multicore optical fiber transmission lines 103 are casually connected to each other, and switching connections is performed, at the other end of the plurality of connected multicore optical fiber transmission lines 103, by the switching connection device 110 such that the channels of the input/output device 104 match the channels of the input/output device 102.

Note that the individual channels 101 and 105 are cores of a plurality of single-core optical fibers, a plurality of waveguides of an optical waveguide circuit, or a plurality of cores of a multicore optical fiber.

The switching connection device 110 may be positioned between the multicore optical fiber transmission lines 103 and the input/output device 102, or may be positioned on both sides. In addition, the switching connection device 110 may be positioned between any of the multicore optical fiber transmission lines 103. The switching connection device 110 only requires positioning at least one position. When the switching connection device 110 is positioned between any of the multicore optical fiber transmission lines 103, the switching connection device 110 switches connections of the individual cores of the multicore optical fiber transmission lines.

Switching the connections of the cores, performed by the switching connection device 110, can set up a desired correspondence relationship between the individual channels 101 of the input/output device 102 and the individual channels 105 of the input/output device 104. Since any cores of the plurality of multicore optical fiber transmission lines 103 are connectable to each other regardless of the presence or absence of the markers of the multicore optical fiber transmission lines 103, the time spent on connection can be shortened. This leads to cost reduction in the phase of constructing or operating an optical transmission line.

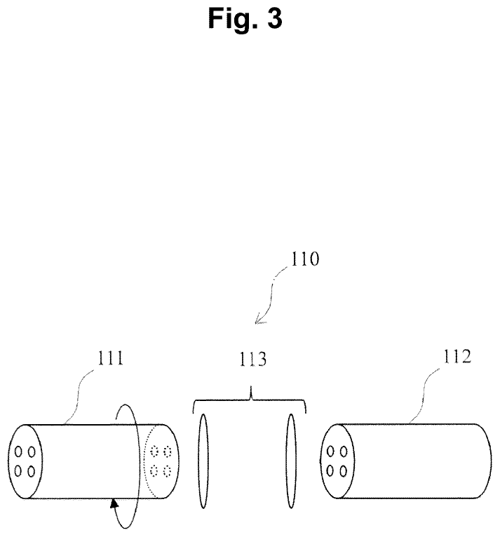

FIG. 3 illustrates a configuration example of the switching connection device 110 of the present embodiment. In FIG. 3, a reference numeral 110 denotes a switching connection device, reference numerals 111 and 112 denote multicore optical fibers, and a reference numeral 113 denotes equal magnification lenses.

The switching connection device 110 switches connections of individual cores disposed on a concentric circle of one multicore optical fiber 111 to individual cores disposed on a concentric circle of the other opposite multicore optical fiber 112 by rotation of the one multicore optical fiber 111 on a central axis thereof. The other multicore optical fiber 112 is fixed, the far end of the one multicore optical fiber 111 is fixed, and the one multicore optical fiber 111 is rotated about the center of the one multicore optical fiber 111 so as to twist the side of the equal magnification lenses 113 of the multicore optical fiber 111. The equal magnification lenses 113 project core images of the one multicore optical fiber 111, forwardly or reversely rotated, onto the cores of the other multicore optical fiber 112 at the equal magnification.

Also in the reverse direction, the equal magnification lenses 113 project the core images, forwardly or reversely rotated, at the equal magnification.

While the one multicore optical fiber 111 is connected to the input/output device 104 in FIG. 2, the other multicore optical fiber 112 may be connected to the multicore optical fiber transmission lines 103 in FIG. 2, and vice versa, with respect to the connection relationship. In addition, while the one multicore optical fiber 111 is connected to the input/output device 102 in FIG. 2, the other multicore optical fiber 112 may be connected to the multicore optical fiber transmission lines 103 in FIG. 2, and vice versa, with respect to the connection relationship. Furthermore, the switching connection device 110 may be positioned between any of the multicore optical fiber transmission lines 103 in FIG. 2, and the one multicore optical fiber 111 and the other multicore optical fiber 112 may be separately connected to the multicore optical fiber transmission lines 103.

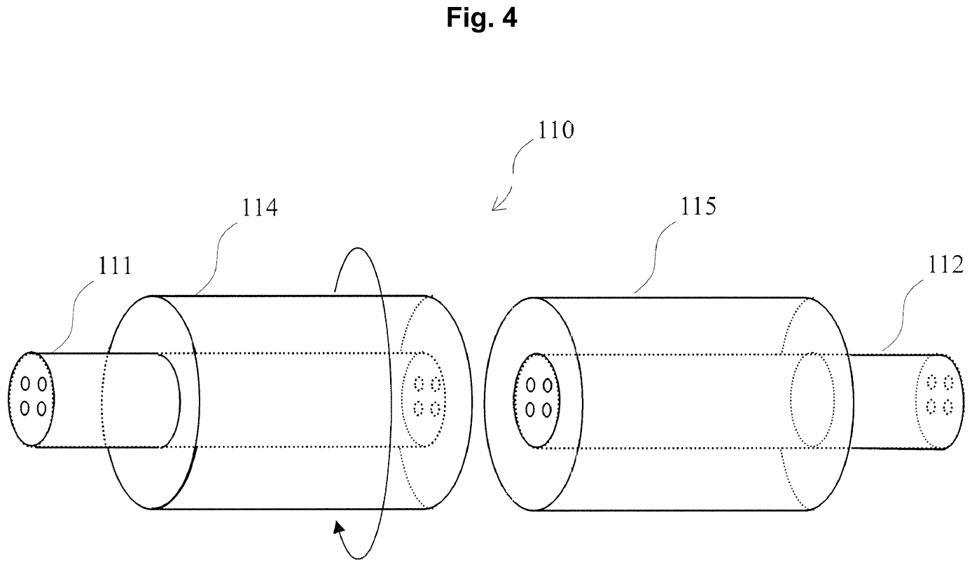

FIG. 4 illustrates a configuration example of the switching connection device 110 of the present embodiment. In FIG. 4, a reference numeral 110 denotes a switching connection device, reference numerals 111 and 112 denote multicore optical fibers, and reference numerals 114 and 115 denote ferrules.

The switching connection device 110 switches connections of individual cores disposed on a concentric circle of one multicore optical fiber 111 to individual cores disposed on a concentric circle of the other opposite multicore optical fiber 112 by rotation of the one multicore optical fiber 111 on a central axis thereof. The ferrule 115 holding the other multicore optical fiber 112 is fixed, the far end of the one multicore optical fiber 111 is fixed, and the ferrule 114 is rotated on the central axis of the one multicore optical fiber 111. In FIG. 4, the end surface of the ferrule 114 is kept at a distance from the end surface of the ferrule 115, but the end surfaces are preferably close to each other as much as possible.

While the one multicore optical fiber 111 is connected to the input/output device 104 in FIG. 2, the other multicore optical fiber 112 may be connected to the multicore optical fiber transmission lines 103 in FIG. 2, and vice versa, with respect to the connection relationship. In addition, while the one multicore optical fiber 111 is connected to the input/output device 102 in FIG. 2, the other multicore optical fiber 112 may be connected to the multicore optical fiber transmission lines 103 in FIG. 2, and vice versa, with respect to the connection relationship. Furthermore, the switching connection device 110 may be positioned between any of the multicore optical fiber transmission lines 103 in FIG. 2, and the one multicore optical fiber 111 and the other multicore optical fiber 112 may be separately connected to the multicore optical fiber transmission lines 103.

As described above, in the optical transmission line and the connection method of the present disclosure, any cores of a plurality of multicore optical fiber transmission lines can be connected to each other regardless of the presence or absence of markers of the multicore optical fiber transmission lines. Therefore, the time spent on connecting the plurality of multicore optical fiber transmission lines can be shortened.

### REFERENCE SIGNS LIST

100 Optical transmission line
101 Individual channels
102 Input/output device
103 Multicore optical fiber transmission line
104 Input/output device
105 Individual channels
106 Core
107 Marker
110 Switching connection device
111 Multicore optical fiber
112 Multicore optical fiber
113 Equal magnification lens
114 Ferrule
115 Ferrule

1. An optical transmission line comprising:
a plurality of multicore optical fiber transmission lines;
two input/output devices that are positioned at both ends of the plurality of multicore optical fiber transmission lines, and configured to input light to or output light from a plurality of cores of the multicore optical fiber transmission lines; and
a switching connection device that is positioned between the multicore optical fiber transmission lines and the input/output devices, and configured to switch connections of the individual cores of the multicore optical fiber transmission lines to individual cores of a multicore optical fiber of the input/output devices.

2. (canceled)

3. The optical transmission line according to claim 1, wherein the switching connection device is configured to switch the connections of the individual cores disposed on a concentric circle of one multicore optical fiber to the individual cores disposed on a concentric circle of another opposite multicore optical fiber by rotation of the one multicore optical fiber on a central axis thereof.

4. A connection method for
a plurality of multicore optical fiber transmission lines and
two input/output devices that are positioned at both ends of the plurality of multicore optical fiber transmission lines, and configured to input light to or output light from a plurality of cores of the multicore optical fiber transmission lines,
the connection method comprising:
switching connections of the individual cores of the multicore optical fiber transmission lines to individual cores of a multicore optical fiber of the input/output devices, between the multicore optical fiber transmission lines and the input/output devices.

5. (canceled)
